(19) United States
(12) Patent Application Publication
(10) Pub. No.: US 2010/0232656 A1
(43) Pub. Date: Sep. 16, 2010

(54) Method and System for Tagging Digital Data

(75) Inventor: Jung-hee Ryu, Seoul (KR)

Correspondence Address: HUSCH BLACKWELL SANDERS LLP, 190 Carondelet Plaza, Suite 600, ST. LOUIS, MO, 63105, US

(73) Assignee: Olaworks, Inc., Seoul (KR)

(21) Appl. No.: 12/223,915

(22) PCT Filed: Aug. 14, 2006
(86) PCT No.: PCT/KR2006/003180

§ 371 Date: Aug. 13, 2008

(30) Foreign Application Priority Data
Feb. 14, 2006 (KR) 10-2006-0014040

(51) Int. Cl. G06K 9/00

(52) U.S. Cl. 382/118

(57) ABSTRACT

A method for attaching a tag to digital data provided from a digital device in a digital data management system includes the steps of: attaching the tag to the digital data automatically according to attributes and contents of the digital data. Moreover, a system for managing digital data produced in a digital device includes: a transceiver for transmitting and receiving the digital data; a database for storing and managing the digital data; and a database engine including a processing unit for automatically extracting a tag from the digital data and then assigning the tag to the digital data. By using the method and the system, a user manages the digital data and shares them with other users. The notable effect is that it provides various tag information in a useful form to the users.

### FIELD OF THE INVENTION

The present invention relates to managing and sharing digital data; and, more particularly, to a method and system for more effectively and appropriately sharing digital data by extracting tag information from the digital data and managing the tag information.

### BACKGROUND OF THE INVENTION

Recently, the amount of digital data, which are shared by a lot of people, has been tremendously increased, while digital devices such as digital cameras, camera-attached mobile communication instruments, digital camcorders and MP3 players are popularized. Since digital data are being frequently produced and widely shared, digital data should be systematically managed. However, it may be difficult to manage digital data (e.g., search and information extraction) due to the massive amount of the information therein.

A scheme for classifying or integrating digital data by using a tag is widely known as one of the conventional techniques for managing digital data. A “tag” can be understood as additional data attached to digital data for the purpose of accessing or searching for the digital data as quickly as possible. Such a tag is generally comprised of a series of characters, numbers, or a combination of numbers and characters.

It is well known that managing digital data by using a tag is useful, especially in terms of the intuitive classification of the digital data based on the recognition by a human being. In case a user has digital data concerning a specific object, he or she may think of various concepts related to the specific object. Assuming that the specific object is a book called “the Jurassic Park,” a well-known novel written by Michael Crichton, he or she may think of the concepts such as “a book,” “a scientific novel,” “Michael Crichton,” and “a dinosaur”. Further, he or she may think of “a favorite writer,” who can be classified as a more private concept, or other concepts such as “a paper cover” and “good condition.” Psychologists understand that even if concepts occurring to users are different, there may be a correlation between the concepts, and such correlation may be a subject for scientific research (the detailed discussion from a standpoint of the psychologist's view is not so important in understanding the technical background of the present invention that it may be shortened here). The user can record these types of concepts into digital data, with some of them being part of a tag and some of them being the entirety of a tag.

Actually, the recorded concept (i.e., tag information) does not differ from the recognition by a human being in the real world. However, once the concept is attached to the digital data as a tag, each concept would be tied to each directory or folder due to the low flexibility of the digital data (i.e., once the digital data is assigned to a specific directory or a folder, it cannot be readily incorporated into other directories or folders). Thus, the digital data cannot be classified and integrated based on the correlation that exists therebetween. Moreover, since the classification of digital data based on the peculiar taste of a user may be different from the classification based on a general recognition, the systematic integration and management becomes more difficult. The low flexibility of digital data can be found in the Windows® Explorer, which is one of the existing data management systems, or a file manager having a directory or folder structure similar to that of the Windows® Explorer. For example, a human being generally recognizes “dog” and “animal” as correlated concepts. However, once a digital photograph having a tag of “dog” is stored at a folder named “dog” and a digital photograph having a tag of “animal” is stored at a folder named “animal,” such a correlation cannot be acquired at all until a correlation between the above two folders is artificially assigned.

Therefore, in order to acquire a plurality of correlations in the tag information of the digital data (i.e., correlations similar to those based on the natural recognition of a human being), the correlations derived from the common recognition shared between a plurality of users should be continuously fed back to a digital data management system. For the purpose of providing such feedback to acquire more precise correlations, the digital data management system is required to be popularized between more users to acquire more generalized correlations between the digital data.

Among digital data management systems adopting the above-mentioned scheme is a web-based system of Flickr™ (http://www.flickr.com) (hereinafter, “flickr”). If a keyword “animal” is inputted to a search field of the system, digital photographs of various animals that have tag information “animal” are to be shown. The digital photographs including various unknown animals as well as well-known animals such as a cat, a penguin, a rabbit and the like could be shown. Herein, a group of the shown digital photographs having some common tags is called “a cluster.” For example, among the “animal” cluster are a plurality of photographs of dogs, which are most popular animals.

As shown in FIG. 4, a link for the “dog” cluster, whose concept is related to the animal cluster, is provided on the web page of “flickr.” Remarkably, the correlation and the link based thereon are achieved through the general recognition of a human being (not an artificial correlation). That is, “flickr” does not give the correlation separately and artificially, but give the correlation by considering a general tendency, which may be derived based on that digital photographs having both the “animal” tag and the “dog” tag are found out so frequently, and may be turned up at the time when users upload the digital photographs through “flickr.” Among the websites performing the function like “flickr” is http://del.icio.us.

Further, as shown in FIG. 5, there is another type of digital data management system, e.g., Picasa™ (http://picasa.google.com) (hereinafter, “PICASA”), which operates on user computers only (Though a web version of has been recently available at http://picasaweb.google.com, the data management scheme of the web version is believed to be like “PICASA”). The features of “PICASA” in terms of digital data management are that one digital photograph can be inserted into several folders by using the sample of the photograph, thereby making the classification of photographs more convenient, and that photographs scattered within the hard disk of the user computer can be organized based on the date the photographs are taken, or other information. However, “PICASA” does not adopt the scheme extracting the correlation between various tag information of digital data based on the general recognition of a human being as mentioned above, but it classifies photographs by using only one attribute, i.e., the shooting date of a photograph.

The conventional data management system as mentioned above is not sufficient to satisfy the various demands of users. For example, in case of “flickr,” users who are going to upload digital photographs to the data management system should attach a tag to each photograph after the upload process. It may be a considerably troublesome work to users. Moreover, since “flickr” does not consider the attributes of tag information at all, the digital data cannot be effectively classified and integrated in spite of the tremendous amount of the tag information. For example, even in case a tag indicating a geographical position called “Alcatraz Island” is attached to a first photograph taken at the Alcatraz Island and a tag indicating a geographical position called “Golden Gate Bridge” is attached to a second photograph taken at the Golden Gate Bridge, there would be very little possibility that the geographical correlation between the two photographs (i.e., the proximity between the places where each photograph was taken) is derived. Rather, the first photograph might be recognized as a photograph that has no relation with the second one. The drawback as above may be found out not only in case of geographical tags but also in case of other types of tags. Furthermore, “PICASA” deviates from the management of digital data based on the natural common recognition of a human being, as described above.

### SUMMARY OF THE INVENTION

It is, therefore, one object of the present invention to provide a novel digital data management method and system enabling a user to manage digital data and share them with other users more conveniently.

Moreover, it is another object of the present invention to provide a novel digital data management method and system capable of providing multi tag information included in one digital data to the users more effectively.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram showing the flow of digital data, which are managed and shared by users in accordance with the present invention;

FIG. 2A is a flowchart of an auto tagging method applied to digital data in accordance with the preferred embodiment of the present invention.

FIG. 2B is a flowchart of an auto tagging method applied to digital data in accordance with another preferred embodiment of the present invention.

FIG. 3 is a flowchart showing a tagging sequence at a digital data management system in accordance with one aspect of the present invention.

FIG. 4 shows an exemplary screen of the conventional digital data management system.

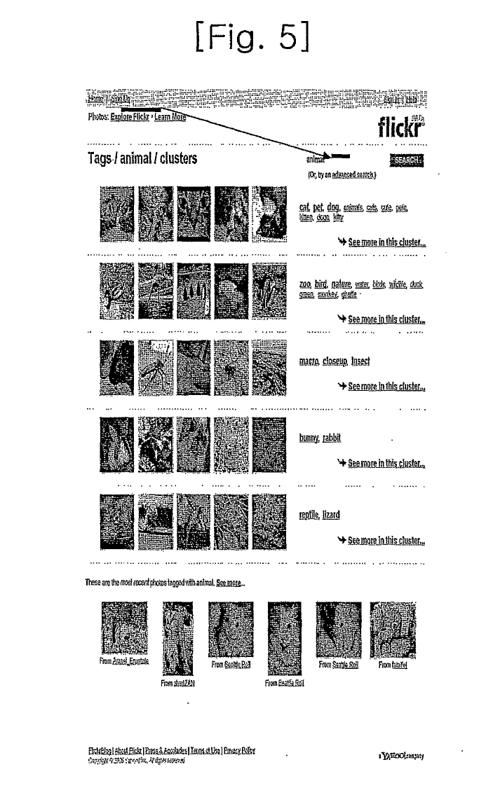

FIG. 5 represents an exemplary screen of the conventional digital data file manager.

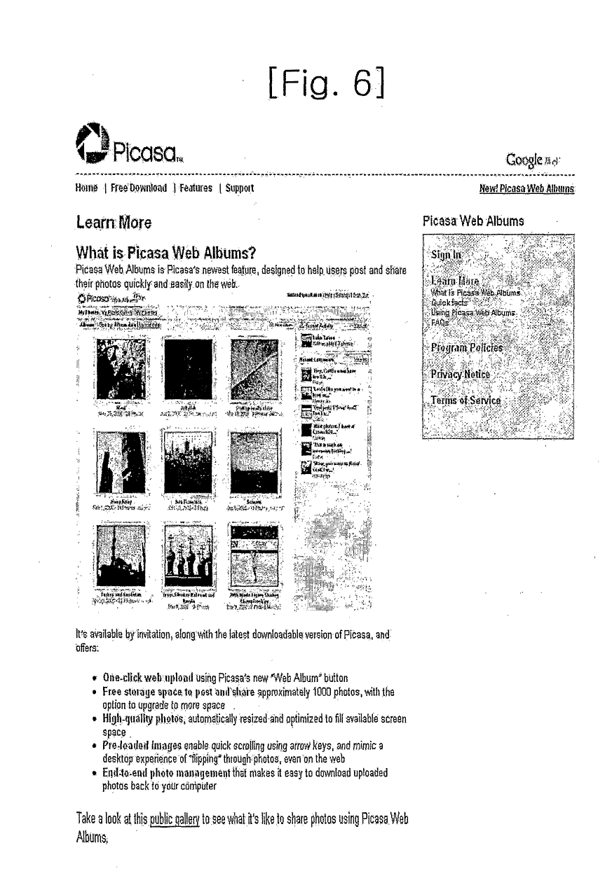

### DETAILED DESCRIPTION OF THE PREFERRED EMBODIMENTS

The detailed description of the present invention illustrates specific embodiments in which the present invention can be performed with reference to the attached drawings.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention.

The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The configurations of the present invention for accomplishing the objects of the present invention are as follows.

In accordance with one aspect of the present invention, there is provided a method for attaching a tag to digital data provided from a digital device in a digital data management system including the steps of: attaching the tag to the digital data automatically according to the attributes and contents of the digital data.

In accordance with another aspect of the present invention, there is provided a system for managing digital data produced in a digital device including: a transceiver for transmitting and receiving the digital data; a database for storing and managing the digital data; and a database engine including a processing unit for automatically extracting a tag from the digital data and then assigning the tag to the digital data.

In accordance with still another aspect of the present invention, there is provided a method for managing a tag of digital data provided from a digital device in a digital data management system including the steps of: attaching the tag to the digital data manually; and automatically classifying the tag into one or more categories among a space, a person, an object and a time in response to the contents of the manually assigned tag.

In accordance with still another aspect of the present invention, there is provided a digital data management system for performing the above-mentioned method including: a transceiver for transmitting and receiving the digital data; a database for storing and managing the digital data; and a database engine including a processing unit for automatically classifying the tag which is manually assigned to the digital data, wherein the processing unit includes a map, an individual index, calendar information, a dictionary and a universal product code.

In accordance with still another aspect of the present invention, there is provided a method for searching for digital data in a digital data management system including the steps of: inputting a keyword for search; selecting the digital data, which includes a tag correlated with the inputted keyword; and providing the selected digital data as a search result, wherein the correlation between the tag and the inputted keyword is determined by referring to at least one among a map, an individual index, calendar information, a dictionary and a universal product code.

In accordance with still another aspect of the present invention, there is provided a method for attaching tags to a plurality of digital data provided from a digital device in a digital data management system including the steps of: collecting one or more digital data correlated with a first digital data among a plurality of digital data; clustering the first digital data and the one or more correlated digital data together to make a digital data cluster; and attaching to the one or more correlated digital data a tag equal to that of the first digital data, wherein the first digital data and the one or more correlated digital data include at least one tag among a time tag and a space tag, wherein, at the step of collecting the correlated digital data, the correlation between the first digital data and the one or more correlated digital data is determined by referring to at least one tag among the space tag and the time tag.

[The preferred embodiment of the present invention]

Flow of Digital Data

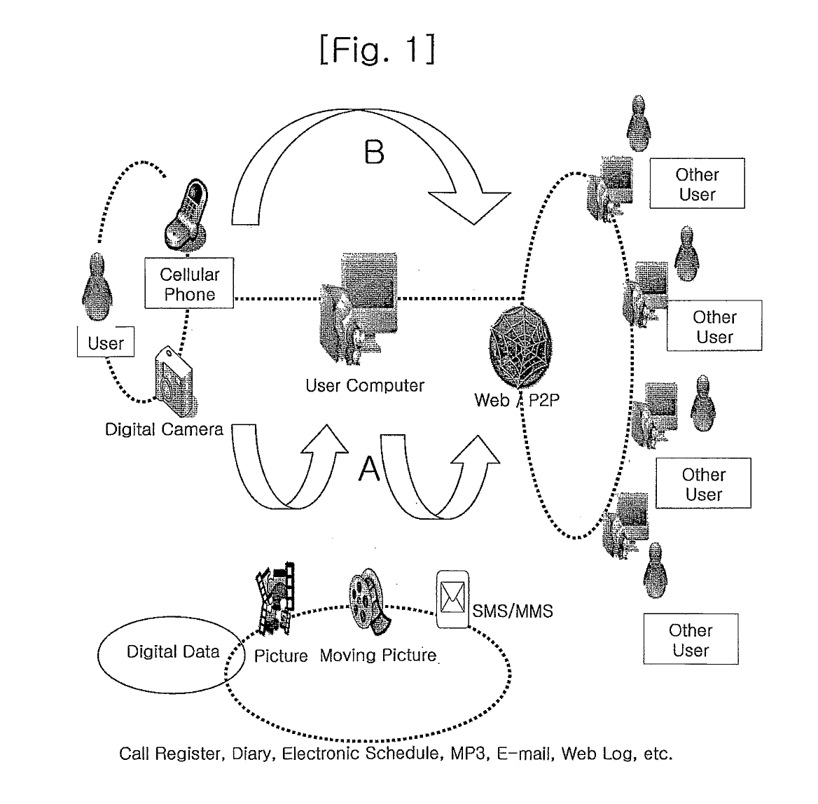

FIG. 1 is a diagram showing the flow of data managed and shared by users in accordance with the present invention.

As shown in FIG. 1, users apply digital devices to produce digital data in a daily life. According to data flow A shown in FIG. 1, the produced digital data is preferentially stored and managed by using a personal computer of a user or any other similar electronic device. The digital data stored in the personal computer and the like are transmitted by the user to a digital data pool within a web server or within a computer of any other user, which is operated under a peer-to-peer (P2P) communications environment. Then, the transmitted digital data is stored in the digital data pool for the purpose of systematic management.

According to data flow B shown in FIG. 1, the digital data produced by using the digital device may be directly transmitted to the digital data pool through built-in data communications module at the digital device. That is, the step of preferentially storing the digital data at the personal computer to manage them systematically can be omitted. Among the exemplary digital devices capable of realizing these data flows is a cellular phone having a function of web connection.

Meanwhile, examples of the digital data produced by users are the picture file, the moving picture file, the messages of the Short Message Service (SMS) or the Multimedia Messaging Service (MMS), the telephone call register, and a diary or an electronically recorded schedule, the MP3 file, the e-mail register, the web log information and the like.

Digital Data Management System

The digital data management system of the present invention may be included in any of user computers, the digital device and the web server as illustrated in FIG. 1. Moreover, the digital data management system of the present invention can be comprised of either the server-client system, which communicates between the user computer (or the digital device) and the web server, or the P2P system, which communicates between the user computer (or the digital device) and other user computer. In general, the digital data management system includes a transceiver for transmitting and receiving digital data, a database for storing and managing the digital data, and a database engine including a processing unit for automatically extracting a tag from the digital data and assigning the extracted tag to the digital data.

Auto Tagging

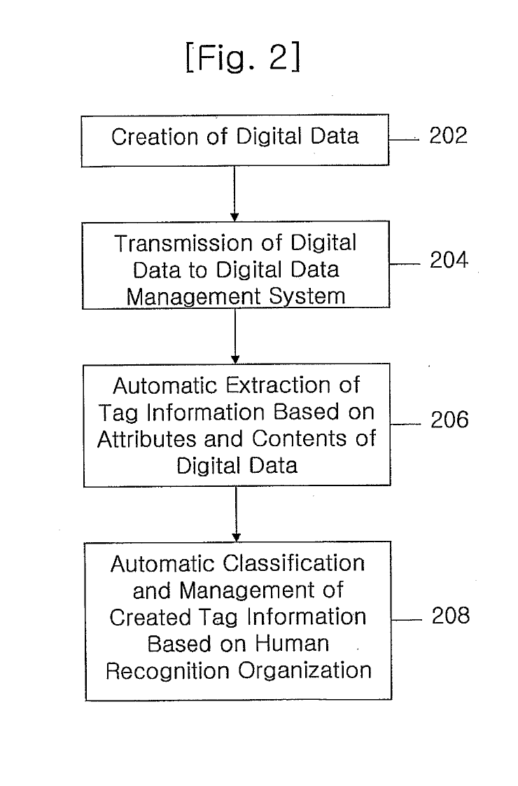

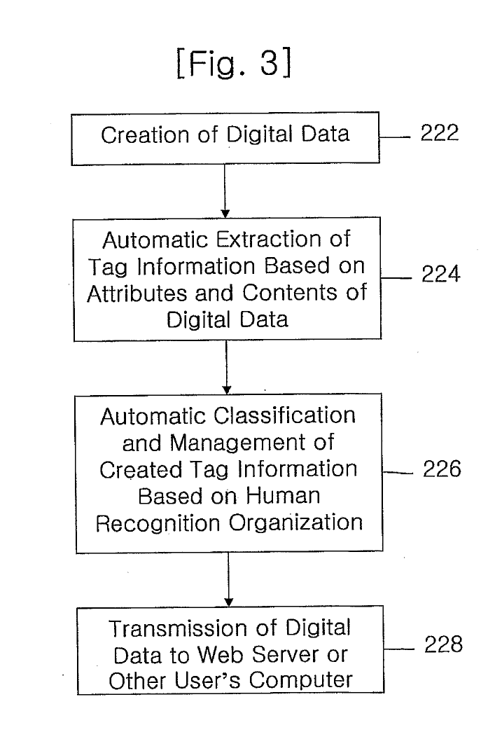

FIG. 2A is a flowchart of the auto tagging method for classifying digital data in accordance with the preferred embodiment of the present invention. As described in the case of “flickr,” etc., it becomes a very troublesome job for a user to manually attach a tag to produced digital data. FIG. 2A is a flowchart in case the digital data management system is located in the web server or other user computer, which is operating under the P2P communications environment. As shown in FIG. 2A, the flowchart includes the steps of producing the digital data by the user (step 202); transmitting the produced digital data to the data management system through a built-in data communications module at the user computer or the digital device (step 204); extracting information for producing the tag automatically (i.e., without having to request the user to input a character string as a tag) in response to the attributes and contents of the digital data transmitted from the digital management system (step 206); and automatically classifying and managing the produced tag information on the basis of the recognition organization of the human being, e.g., 6W 1H (step 208).

FIG. 2B is a flowchart of the auto tagging method for classifying digital data in accordance with another preferred embodiment of the present invention. FIG. 2B is a flowchart in case the digital data management system is located in the digital device or the user computer. As shown in FIG. 2B, the digital data is produced by the user (step 222), and then the information is extracted from the digital data to automatically produce a tag according to the attributes- and the contents of the digital data at the digital management system (step 224). Thereafter, the produced tag information is classified automatically for the management thereof on the basis of the recognition organization of the human being (step 226), and then the digital data with the tag attached thereto may be transmitted to the web server or the other user computer for the purpose of sharing the digital data with many other people and integrating them with any other digital data generated by other users (step 228).

As known, 6W 1H refers to the information on the who, the when, the where, the what, the why, the how, and the wherefore. The tag information that is automatically assigned to the digital data is classified according to 6W 1H at the time of the production thereof. In accordance with the present invention, the preferable examples of the information automatically extracted from the digital data among 6W 1H are the space, the person, the object, the time (which may be called “SPOT” by picking up the initial character thereof) and the like. Besides, information on the event etc. can be tagged automatically.

The auto tagging merely represents that specific tag information is automatically assigned to the digital data, but does not mean that a manual tagging should be abandoned. In accordance with the present invention, all the user interfaces for attaching the tag manually may be provided to users like the conventional system.

Hereinafter, a method for producing and managing the tag information automatically based on “SPOT” would be expounded in detail.

Space Tag (S)

In accordance with one aspect of the present invention, the method for automatically producing tag information on the space (location) and attaching the same to the digital data would be explained.

As described above, the digital data is produced by using a digital device. The digital device may be operated appropriately by connecting to the mobile network employing the cellular communications system or to the Global Positioning System (GPS) through the satellite communications. Further, in some cases, the digital device may be operated appropriately by connecting to both the mobile network and the global positioning system, like the case of network-assisted GPS, which has been recently developed (for example, the gpsOne® of Qualcomm Corp. in the U.S.A.).

In this way, a method for automatically producing the space tag information and attaching the same to the digital data, which are generated from the digital device that is connected to the mobile network or the global positioning system, is as follows:

Method for Connecting Digital Device to Mobile

Network to Produce Space Tag

The technical core of the known mobile communications is that a mobile station (a terminal like a digital device) transmits/receives an electric wave not only to/from one base station but to/from a plurality of base stations placed at predetermined intervals. Each of the base stations has a geographic area, i.e., a cell, for communicating with the mobile station. Each of the base stations is located at the center of each cell in consideration of geographical conditions and propagation conditions. The base station is connected to a mobile switch so that the request for information and the retransmission of the information, both through the mobile switch, is practicable.

In accordance with a preferred embodiment of the present invention, the mobile station can obtain various kinds of basic information on the base station (for example, a characteristic number of the base station) if a communication channel is established between the base station and the mobile station. Since the location of each base station is fixed, the characteristic number of the base station corresponds to location information representing the location of the base station, such as coordinates or a geographical designation, etc. The location information on the base station may be included in the base station itself or in a server of the mobile switch. Therefore, the mobile station can, by a request or originally, obtain the location information on the base station. By considering the location information on this base station, the location information on the mobile station positioned within the restricted cell region of the base station can be found out. The mobile station is considered to be positioned within a domain restricted by the maximum cell size of the base station, or to be positioned within a domain smaller and narrower than the maximum cell size. The size of the domain in the latter case may be determined based on the intensity of a pilot signal through the pilot channel, which is set up between the mobile station and the base station. Therefore, the location information on the mobile station may be expressed in the form of a geographical range where the mobile station is positioned. For example, the location information on the mobile station as described above can be obtained in the form of one log through the mobile network, e.g., from the mobile station, from the base station, or from the server of the mobile switch, by referring to time information included in the mobile station. The acquisition of the location information in the form of a log can be directly (i.e., by computing the location information at the mobile station, the base station, or the server of the mobile switch) or indirectly (i.e., by calling for the information generated in other node on the mobile network) performed through the mobile station, the base station, or the server of the mobile switch. The location log may become useful information on the place the mobile station was positioned at a certain time. Besides, the location information on the mobile station can be obtained by using a well-known realtime positioning technology.

Therefore, in accordance with the present invention, the digital device can obtain its location information at the time when the digital data is produced. In detail, such location information can be obtained by referring to the time information included in the digital data produced by the digital device (i.e., the mobile station) and the location log (as described later, the digital data generally includes the information on the timing it is generated). Space tag information is provided to the digital data as a result of the automatic assignment of the location information.

Method for Producing Spate Tag by Connecting to Global Positioning System

Recently, the global positioning system is known to be applied to determining the location of an electronic device. In general, the global positioning system includes the GPS receiver, which receives a GPS satellite signal and then determines the location of the GPS receiver (that is, the location of the electronic device) on the basis of the received GPS satellite signal. Applying the well-known triangulation, which makes use of geographical relations between the GPS receiver and three or four GPS satellites that are apart from the GPS receiver by a pseudorange, may determine the location of the GPS receiver. Therefore, in accordance with another preferred embodiment of the present invention, in case of a digital device having a built-in GPS receiver, the space tag information may be automatically attached to the digital data by using the location information of the GPS receiver obtained at the time when the digital data is generated.

Method for Producing Space Tag by Connecting to Network-assisted GPS

Recently, the Qualcomm Corp. in the U.S.A. has disclosed a technology for chasing a location by combining a mobile communication methodology with a satellite communication methodology through a product called the gpsOne®. The kernel of the technology is that the location of the GPS receiver is chased not only by the satellite communications but also by the communications between the mobile station and the base station in the mobile network. So to speak, since the information on the location of the mobile station can be obtained by using the fixed location of the base station, the preciser information on the location can be obtained by integrating it with a chased location through the GPS (refer to “gpsOne® Position Location Technology” distributed on the website of the Qualcomm Corp., i.e., http://www.cdmatech.com).

In accordance with another preferred embodiment of the present invention, it is possible to produce the space tag information on the digital data and then automatically attach them to the digital data with the help of network-assisted GPS technology.

Needless to say, there may be other schemes for automatically assigning space tag information to digital data. Digital data may include useful information on the space for their own. For example, it may be the information on a related mobile switch in case of a message (e.g., SMS) and a telephone call register, or the information on a place where to meet in case of a schedule. Besides, a relevant space tag may be given to the digital data by extracting the information on a geographical designation from a traffic sign, the picture of which can be taken by a digital camera and which can be read by the character recognition scheme described later, or the information on the well-known landmark, such as the Eiffel Tower, which can be identified by the pattern recognition scheme described later. This type of information can be classified as the space tag information of the digital data. Moreover, at least part of the information may be tagged automatically.

Hereinabove, the technology for automatically assigning space tag information to digital data has been reviewed in accordance with the present invention. In accordance with the preferred embodiment of the present invention, space tag information may have a form of specific coordinates or a range thereof, representing, e.g., the latitude, the longitude, the altitude and the like. In accordance with another preferred embodiment of the present invention, space tag information may include a geographical designation corresponding to specific coordinates, or a firm name or a building name located at specific coordinates by referring to the coordinates and the map which may be included in the digital data management system.

—Person Tag (P)

In accordance with another aspect of the present invention, the auto tagging may involve a person tag recognized from digital data.

In accordance with a preferred embodiment of the present invention, digital data may include useful information on a person for their own. For example, it may be the information on a photographer in case of the picture file or the moving picture file, the information on an addresser or an addressee in case of a message, the telephone call register, or e-mail register, the information on a singer or an author or the like in case of the MP3 file, the information on a user in case of the web log information, the information on the owner of a diary in case of a diary, or the information on the people whom to meet in case of a schedule. This type of information may be classified as the person tag information of the digital data. Moreover, at least part of the information may be tagged automatically.

In accordance with another preferred embodiment of the present invention, the auto tagging may be implemented by recognizing an individual through the conventional face recognition scheme and the like. Among the conventional methods for managing the digital data by using a face recognition scheme is “Method and Apparatus for Organizing Digital Media Based on Face Recognition,” which was invented by Yasuhiko Nagaoka, etc. and filed as U.S. Patent application Ser. No. 10/734,259 on Dec. 15, 2003 (opened to the public as U.S. Patent Laid-open Publication No. 2005-105806 on May 19, 2005) (this specification should be considered to include the contents of U.S. patent application Ser. No. 10/734,259). According to the above-mentioned U.S. patent application, a method for organizing digital photographs on the basis of a face recognition scheme includes the steps of: extracting specific face objects from a plurality of digital photographs; cropping the plurality of the digital photographs to produce the isolated images of the face objects; applying a recognition algorithm to determine a similarity of the isolated images with a reference; displaying the face objects arranged as a function of the determined similarity; and receiving the user input to correlate the face objects with a specific classification. Among the websites providing the face recognition scheme is www.riya.com.

In accordance with the present invention, a plurality of digital photographs, in which individuals are appearing, can be organized and classified as a function of the similarity of the looks of the individuals. Thus, a person tag may be attached to the digital photographs automatically. For example, if photographs, for which “Bill Clinton” is already recorded as a person tag, are classified by the person tag and other photographs, which are considered to include the same person therein by the face recognition scheme, are inputted, all the photographs can be automatically assigned a person tag of “Bill Clinton.” Moreover, the digital data management system in accordance with the present invention may receive confirmation of a user to determine whether the person tag automatically attached to the photographs is correct or not. Therefore, it is possible to reduce errors through a feedback, i.e., the confirmation of the user.

Object Tag (O)

In accordance with another aspect of the present invention, an object tag may be automatically attached to digital data by referring to the information on an object recognized from the digital data.

In accordance with another preferred embodiment of the present invention, since digital data include useful information on an object for their own, the auto tagging can be realized. For example, the information may be the entirety or a part of the file name of the digital data stored as a file format. Further, the information may be the entirety or a part of the information recorded in the title line in case of an e-mail register or a diary, or the information obtained by running the well-known search program in case of all the text-type digital data (for example, an e-mail register). This type of information may be used as an object tag of the digital data. Moreover, the information can be tagged automatically. However, there are so many objects with various shapes (unlike in case of person tagging), that it is not easy to properly extract object tag information by a simple analysis on the objects.

In accordance with another preferred embodiment of the present invention, in order to solve the above-mentioned problem, i.e., to extract an object tag easily, a method is suggested as follows:

Method for Producing Object Tag by Recognizing Character in Image

Heretofore, a technology for recognizing the character in the images of digital photographs has been studied in various ways. For example, “Character Recognition Apparatus and Method of the Mobile Terminal,” which was filed as Korean Patent Application No. 2003-86875 on Dec. 2, 2003 (opened to the public as of Jun. 8, 2005 as Korean Laid-open Publication No. 2005-53236) by the LG Electronics Inc., may be referred to (the contents of Korean Patent Application No. 2003-86875 should be considered to be integrated with this specification). According to the above-mentioned invention, disclosed is a method for optimally recognizing a character, which may be realized by the steps of: scaling-up or scaling-down a photographed image, which is inputted on the frame-by-frame basis, to obtain character information; binarizing the obtained character information; comparing the binarized character information with a character code database created on the statistic base. Moreover, as another example, “Character Recognition System,” which was filed as Korean Patent Application No. 2002-7005587 on Apr. 30, 2002 by the Hewlett-Packard company (opened to the public as of Oct. 26, 2002 as Korean Laid-open Publication No. 2002-81210), while Japanese Patent Application No. 2000-262096 is a basis for claiming the priority right of the above-mentioned application, may be referred to (the contents of the Korean Patent Application No. 2002-7005587 should be considered to be integrated with this specification). According to this, disclosed is a method for recognizing a character including the steps of: extracting a specific vector; comparing the specific vector with a reference vector; and selecting a character, whose distance value is obtained by the Euclidean calculation on the specific vector and the reference vector and accordingly is being minimum. Furthermore, “Mobile Handset and Method for Selecting an Objective Area of the Character Recognition on the Mobile Handset,” which was filed as Korean Patent Application No. 2004-89371 on Nov. 4, 2004 (opened to the public as of May 17, 2005 as Korean Laid-open Publication No. 2005-45832) by the Hitachi OMRON Terminal Solutions Inc., while Japanese Patent Application No. 2003-379288 is a basis for claiming the priority right of the above-mentioned application, may be referred to (the contents of the Korean Patent Application No. 2004-89371 should be considered to be integrated with this specification). According to this, disclosed is the technology for enhancing the character recognition by appropriately modifying an inclination of an object character and extracting a row of the object character.

In accordance with one preferred embodiment of the present invention, the recognized character in the image of a digital photograph may be attached to the digital data as an object tag by applying these technologies. This tag is useful in case a character occupies a great portion in the image of the digital photograph. Among the above-mentioned characters is a trademark attached to a product.

Method for Recognizing Pattern in Image to Produce Object Tag

Heretofore, a technology for recognizing the pattern in the images of the digital photographs has been studied in various ways. For example, “Shape Detecting Device,” which was filed as Korean Patent Application No. 1995-566 on Jan. 14, 1995 (opened to the public as of Aug. 18, 1995 as Korean Laid-open Publication No. 1995-23966) by the Matsushita Electric Industrial Co., Ltd., while Japanese Patent Application No. 1994-3333 is a basis for claiming the priority right of the above-mentioned application, may be referred to (the contents of Korean Patent Application No. 1995-566 should be considered to be integrated with this specification). According to the above-mentioned invention, disclosed is an apparatus for recognizing a pattern, which may be realized by the steps of: photographing an object; outputting image information on the object; digitalizing the outputted image information to create image data; determining an approximate location of the object; detecting edge points of the object by the concentration of the image information; and deriving a contour by integrating the detected edge points. Furthermore, “Pattern Detecting Method,” which was filed as Korean Patent Application No. 1994-16927 on Jul. 14, 1994 (opened to the public as of Feb. 18, 1995 as Korean Laid-open. Publication No. 1995-5034) by the Matsushita Electric Industrial Co., Ltd., while Japanese Patent Application No. 1993-174134 and Japanese Patent Application No. 1993-194355 are bases for claiming the priority right of the above-mentioned application, may be referred to (the contents of Korean Patent Application No. 1994-16927 should be considered to be integrated with this specification). According to this, disclosed is the technology for recognizing a pattern, in case the image of the target object has an edge (i.e., conspicuous change of the concentration). This technology involves the steps of: dividing an image on a pixel-by-pixel basis; and calculating a correlation value of a regional concentration to detect an object in the image more precisely.

In accordance with one preferred embodiment of the present invention, it becomes possible to recognize and extract patterns such as a trademark, a design, and a model in the image of the digital photograph from the digital data, and thereby attach them to the digital data as an object tag.

Method for Recognizing Bar Code to Create Object Tag

Among the well-known technologies for the object recognition is the barcode recognition technology. The bar code, a combination of characters, numbers, or special characters with different thickness of lines, represents a code that can be read optically in the visible band of the light. It is used for various purposes. For example, it may be printed on a packing paper of a product to indicate its'cost, or printed on a cover of a book to manage a plurality of books in the library, or printed on various time cards or the like.

In accordance with another preferred embodiment of the present invention, digital devices can automatically obtain an object tag through the barcode recognition as described above. In accordance with the present invention, for the purpose of reducing errors which may occur in discriminating specific objects, not only the combination of the lines with different thickness in the bar code but also the numbers or the characters accompanying the lines are recognized by the character recognition technology.

Method for Creating Object Tag through Radio Frequency IDentification (RFID)

Among the well-known technologies for the object recognition is the RFID technology. The RFID is a technology using the electromagnetic or the electrostatic coupling in the radio frequency band of the electromagnetic spectrum in order to distinguish objects. In the industrial circles, the RFID is being popularized more and more, which is expected to replace the barcode recognition technology in the end. The advantage of the RFID is that there is no need to contact an object directly or scan the same in the visible band. The RFID system includes an antenna, a transceiver (generally integrated with a reader) and a transponder. The antenna uses the radio frequency wave in order to transmit a signal for activating the transponder. When activated, the transponder transmits data to the antenna. The data is generally handed over to a control logic performing various computation works, e.g., while the object passes through a door or sales transactions with a database in association.

In accordance with another preferred embodiment of the present invention, a digital device receives information on an object from the activated transponder of the RFID system to assign the information to the digital data as an object tag, automatically. As described above, the object tag may be a more compressive and intuitive format than the original information transmitted from the RFID system.

In accordance with a preferred embodiment of the present invention, the object tag may be stored as a well-known name of an object. In accordance with another preferred embodiment of the present invention, the object tag may be stored in the form of a code indicating a product, such as the Universal Product Code (UPC) or the European Article Number (EAN) code.

Time Tag (T)

In accordance with another aspect of the present invention, a time tag can be automatically assigned to digital data.

As described above, the time tag may be most easily extracted from the digital data. For example, the Exchangeable Image File Format (EXIF) of the digital photograph or the ID3 tag of the MP3 file already includes time information. Moreover, in case of the Windows® system, information on dates and times when files are generated are assigned to all kinds of the digital data, automatically. In accordance with a preferred embodiment of the present invention, the digital data obtains the time information as described above by using a clock within a digital device, and a time tag extracted from the time information may be assigned to the digital data automatically. To extract the time tag automatically from the digital data in the form of regular time indication is useful for the search of the digital data. In other words, a tag recorded in the form of “Dec. 25, 2005 12:00” may be more advantageous in various searching operations than a tag inputted as “Christmas in 2005.” Accordingly, digital data created during a specific period of time, e.g., p.m. 3:00-4:00, on Dec. 25, 2005 are easily accessible owing to the precise time indication.

Needless to say, it is also preferable to adopt both of the search methods, i.e., a character string search using, e.g., “Christmas” and a time search using, e.g., “p.m. 3:00-4:00, on Dec. 25.”

Correction and Addition of Tag

As mentioned above, the digital data stored in the digital data management system automatically includes tag information classified by a space (S), a person (P), an object (O) and a time (T). However, these kinds of the tag information are not always fixed. Moreover, user's various choices may be considered in determining the kinds of the tag information.

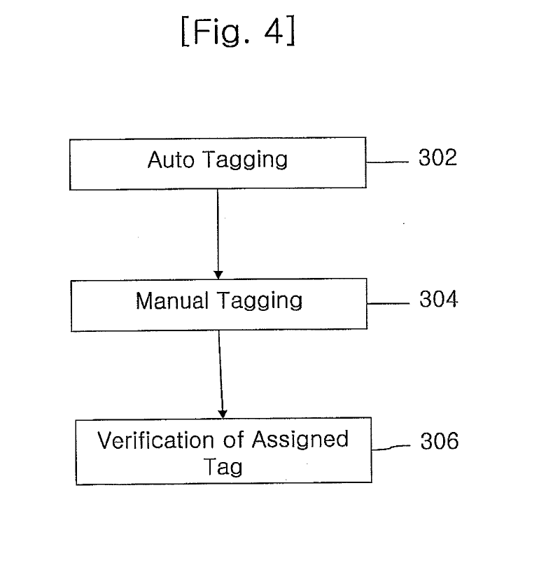

FIG. 3 shows a procedure of inputting a tag at the digital data management system in accordance with one aspect of the present invention. As presented in FIG. 3, the digital data management system performs the auto tagging in the same way as explained above (302). The number of tags, which are assigned automatically, may be at least one depending on the type or the quality of the digital data.

For example, in case of the digital photograph taken of a person's face, a person tag may be obtained with a help of the face recognition technology, i.e., by recognizing the person in the digital photograph, and then comparing the face of the person with previously stored face data. Moreover, the time when the photograph is taken can be used for the time tag. Therefore, this digital photograph can automatically obtain two types of tag information, i.e. the person tag and the time tag. However, the tag information that is assigned automatically can be manually modified by the user, and further, another desired tag value can be added to the tag information (304). Thereafter, the modified tag information is attached to the digital data, ultimately (306). In this case, the modified tag information, which is ultimately assigned to the digital data, may have a form consistent with a tag assigned automatically in accordance with the present invention.

Automatic Classification of Manually Assigned Tag

In accordance with another aspect of the present invention, there is provided a method for attaching tag information manually to the digital data without the auto-tagging procedure, like the conventional digital data management system. However, in accordance with the present invention, there is provided a method for classifying the manually tagged information on a basis of SPOT (or SPOT+E (Event)), as explained above.

In accordance with a preferred embodiment of the present invention, if a user inputs a geographical designation called “Washington D.C.” for the tag information, the inputted tag information may be classified as a space tag by referring to map information included in the digital data management system. In this case, the space tag in the form of the geographical designation may be expressed by using a form of coordinates, or the space tag may be expressed in the form of both the coordinates and the designation name. Like the auto-tagging, the coordinates may be expressed as a range of the coordinates.

Moreover, in accordance with another preferred embodiment of the present invention, if manually assigned tag information is a name or an alias of a person, the digital data management system refers to its person index included therein to classify it as a person tag. Herein, the person tag may be expressed in the form of a user's ID of the person.

In accordance with another preferred embodiment, if manually assigned tag information is a name of an object, it is classified automatically as an object tag by referring to a dictionary or the UPC included in the digital data management system. In this case, the object tag may be automatically replaced to the form of the product code or expressed by jointly using a manually assigned tag.

In accordance with another preferred embodiment of the present invention, if manually assigned tag information relates to a time such as “Christmas,” it is classified automatically as a time tag by referring to a calendar or the time information included in the digital data management system. Moreover, the classified time tag may be automatically replaced by a more regular time indication or expressed by using both the manually assigned tag and the regular time indication. Furthermore, the time tag expressed as “December 25” can be replaced with a text-based tag such as “Christmas.”

On a related discussion, in accordance with the present invention, a user interface enabling a user to input a tag conveniently in a manual way is provided. For example, in order to add and correct the time tag conveniently, GUIs such as a map, a calendar or a clock may be provided. Besides, an existing list of a personal index or a personal photograph may be also provided for the user's convenience. Moreover, tags frequently used by a group, which a user belongs to, may be provided through e graphic user interface. Herein, as the tags are more frequently used by the users, a larger number of tags will be shown on the graphic user interface.

### Cluster Tagging

In accordance with one aspect of the present invention, a peculiar cluster tagging may be proposed.

The digital data may be created by using a digital device at any time and at any place. However, due to the discontinuity of the time when the digital data is created or the place where the digital data is generated, the digital data shows a discontinuous distribution. It is derived from the fact that, in a daily life, the digital data tends to be produced only in certain time and place by a user. For example, digital photographs have a tendency to be mostly taken at the time when a user was actively involved (for example, at a birthday party) and in the place where a user was actively involved (for example, the Eiffel Tower and its neighboring place). Therefore, the cluster tagging for clustering relevant digital data into one cluster by acquiring the place or the time pertaining to the various digital data, and assigning a common tag to all the relevant digital data may be effective. In order to acquire the common place or the common time, the space tag or the time tag obtained in various ways as described above may be utilized.

Hereinafter, the cluster tagging in accordance with preferred embodiments of the present invention are presented.

First, the cluster tagging based on a time tag is realized. Suppose that a user attends a birthday party of his/her friend and takes many digital photographs there. In this case, the shooting mainly occurs at the birthday party time, e.g., only for 3 or 4 hours. However, other photographs stored in the identical digital camera may probably be taken several days before/after the birthday party time. In this case, the digital data management system can automatically or manually classify the photographs taken at the birthday party among all the photographs stored in a user's camera into one event cluster. Moreover, if a user attaches an event tag called “the birthday party” to a photograph, the other photographs within the corresponding cluster may be also assigned the identical tag. Besides, a tag attached to some of the digital data in a specific cluster (for example, the person tag or the space tag, etc.) may also be attached to the rest of the digital data in the specific cluster.

The cluster tagging is also possible on a basis of the space tag. For example, the digital photographs taken around the Eiffel Tower may include photographs with an image of the Eiffel Tower or other things. In accordance with the present invention, the photograph having the image of the Eiffel Tower may include coordinates corresponding to the location of the Eiffel Tower as a space tag by adopting the technology for acquiring the location information through the mobile communications network or the pattern recognition technology. In the meantime, some of photographs taken around the Eiffel Tower do not have the same coordinates as those of the Eiffel Tower but have coordinates very close to the Eiffel Tower. Such coordinates may be used as a space tag. Needless to say, some photographs among all the photographs stored in the user's digital camera may have coordinates considerably far from those of the Eiffel Tower as a space tag. By discerning these coordinates, the digital data management system can cluster only the photographs having coordinates close to those of the Eiffel Tower as a space tag, and classify them into one cluster, which is directed to the Eiffel Tower. Herein, if a user attaches an event tag, e.g., “the Eiffel Tower” to one of photographs within the cluster, the other photographs within the cluster may be endowed with the same tag. Besides, a tag assigned to some of the clustered digital data (for example, a person tag or a space tag, etc.) may also be used as a tag for the rest of the clustered digital data.

The cluster tagging may provide greater convenience to the users.

Usage of Tag Information

As described above, in accordance with the present invention, the tag information may be automatically given to the digital data on a basis of the general recognition of a human being. Moreover, the tag information helps the users search for desired digital data and conveniently extract more abundant correlations therebetween. In accordance with a preferred embodiment of the present invention, a space tag may be at least one of a geographical designation, coordinates and a range thereof, so that both the geographical designation and the coordinates can be used as keywords for the search and the geographical correlations between the adjacent regions can be easily recognized. Moreover, in order to recognize correlations between people more precisely, additional information such as an alias or an ID of a user may be a keyword for the search. Furthermore, a world-wide product code may be stored as an object tag, so that the correlations between the products can be recognized easily. In addition, if the digital data management system includes one or more bilingual transfer dictionaries, the ranges of the search and the correlation may be expanded to the different languages. Besides, since the time tag may be stored in the form of a time range, it also provides great convenience to the users for search.

### EFFECT OF THE INVENTION

In accordance with the present invention, there is provided a method for automatically assigning a space tag, a person tag, an object tag and a time tag to digital data according to the attributes and contents of the digital data and/or classifying the assigned tag information, for the purpose of managing the digital data and sharing them with other users more conveniently.

Moreover, the present invention provides a plurality of tags attached to the digital data to the users in more useful ways.

While the invention has been shown and described with respect to the preferred embodiments, it will be understood by those skilled in the art that various changes and modifications may be made without departing from the spirit and scope of the invention as defined in the following claims.

1-41. (canceled)

42. A method for attaching at least one tag to digital data provided from a digital device in a digital data management system, the digital data management system including a database, comprising the steps of:
automatically obtaining one or more kinds of information among information on a space, a person, an object and a time, associated with the digital data; and
attaching the obtained information to the digital data as tag information,
wherein the information on the space is obtained from a certain location where the digital device is located, information on the certain location being acquired by at least one of a global positioning system and a mobile communications system,
wherein the information on the person is obtained from information on a specific person whose facial image(s) is stored in the database, in case the digital data provided from the digital device includes a facial image of a certain person and the certain person is determined to be identical to the specific person by comparing the facial image of the certain person with that of the specific person on the basis of a face recognition scheme,
wherein the information on the object is obtained by recognizing at least one of a character and a pattern associated with a certain object included in the digital data, in case the digital data includes the image of the certain object, and
wherein the information on the time is obtained from a certain time at which the digital data is generated.

43. The method of claim 42, wherein the information on the space is assigned to the digital data as the tag information in the form of at least one of geographical coordinates and a geographical designation corresponding thereto.

44. The method of claim 42, wherein, in case the digital data includes an image of a geographical designation, the information on the space is further obtained by recognizing a character related to the geographical designation included in the digital data.

45. The method of claim 42, wherein, in case the digital data includes an image of the landmark, the information on the space is further obtained by recognizing a pattern related to the landmark included in the digital data.

46. The method of claim 42, wherein, in case an image of the certain object includes a pattern of a bar code, the information on the object is obtained by recognizing a combination of a plurality of lines having different thicknesses from each other within the bar code.

47. The method of claim 42, wherein, in case an image of the certain object includes a pattern of a bar code, the information on the object is obtained by recognizing a combination of a plurality of lines having different thicknesses from each other within the bar code, and by recognizing a number and a character corresponding to the combination.

48. The method of claim 42, wherein the information on the object is further obtained by using Radio-Frequency Identification (RFID) information, in case the digital data includes the RFID information.

49. The method of claim 42, wherein the information on the object is assigned to the digital data as the tag information in the form of Universal Product Code (UPC) or European Article Number (EAN).

50. A system for managing digital data created by a digital device comprising:
a transceiver for transmitting and receiving the digital data;
a database for storing and managing the digital data; and
a database engine including a processing unit for automatically extracting one or more kinds of information among information on a space, a person, an object and a time, from the digital data and then attaching the extracted information to the digital data as tag information,
wherein the processing unit includes:
a space tag extracting unit for extracting the information on the space from a certain location where the digital device is located, information on the certain location being acquired by at least one of a global positioning system and a mobile communications system;
a person tag extracting unit for extracting the information on the person from information on a specific person whose facial image(s) is stored in the database in case the digital data provided from the digital device includes a facial image of a certain person and the certain person is determined to be identical to the specific person by comparing the facial image of the certain person with that of the specific person on the basis of a face recognition scheme;
an object tag extracting unit for extracting the information on the object by recognizing at least one of a character and a pattern associated with a certain object included in the digital data, in case the digital data includes the image of the certain object; and
a time tag extracting unit for extracting the information on the time from a certain time at which the digital data is generated.

51. The system of claim 50, wherein the processing unit assigns the information on the space to the digital data as the tag information in the form of at least one of geographical coordinates and a geographical designation corresponding thereto.

52. The system of claim 50, wherein, in case the digital data includes an image of a geographical designation, the space tag extracting unit further extracts the information on the space by recognizing a character related to the geographical designation included in the digital data.

53. The system of claim 50, wherein, in case the digital data includes an image of the landmark, the space tag extracting unit further extracts the information on the space by recognizing a pattern related to the landmark included in the digital data.

54. The system of claim 50, wherein, in case an image of the certain object includes a pattern of a bar code, the object tag extracting unit extracts the information on the object by recognizing a combination of a plurality of lines having different thicknesses from each other within the bar code.

55. The system of claim 50, wherein, in case an image of the certain object includes a pattern of a bar code, the object tag extracting unit extracts the information on the object by recognizing a combination of a plurality of lines having different thicknesses from each other within the bar code, and a number and a character corresponding to the combination.

56. The system of claim 50, wherein the object tag extracting unit further extracts the information on the object by using RFID information, in case the digital data includes the RFID information.

57. The system of claim 50, wherein the processing unit assigns the information on the object to the digital data as the tag information in the form of UPC or EAN.
